(19) United States
(12) Patent Application Publication
(10) Pub. No.: US 2023/0303041 A1
(43) Pub. Date: Sep. 28, 2023

(54) STROKE SENSING APPARATUS FOR BRAKE PEDAL

(71) Applicant: HYUNDAI MOBIS CO., LTD., Seoul (KR)

(72) Inventors: Ju Ho LEE, Yongin-si (KR); Chan Jun HA, Yongin-si (KR)

(73) Assignee: HYUNDAI MOBIS CO., LTD., Seoul (KR)

(21) Appl. No.: 18/067,347

(22) Filed: Dec. 16, 2022

(30) Foreign Application Priority Data
Mar. 25, 2022 (KR) 10-2022-0037663

(51) Int. Cl. B60T 7/04; G01D 5/14

(52) U.S. Cl. CPC B60T 7/042; G01D 5/14; B60T 2220/04

(57) ABSTRACT

A stroke sensing apparatus for a brake pedal includes a pedal rod moved by an operation of the brake pedal; a magnet part mounted on the pedal rod and moved together with the pedal rod; a sensor spaced apart from the magnet part; a printed circuit board (PCB) part on which the sensor is mounted; and a pole piece part mounted on the PCB, spaced apart from the magnet part, and transmitting a magnetic field change generated in the magnet part to the sensor.

### CROSS-REFERENCE TO RELATED APPLICATIONS

This application claims the benefit under 35 U.S.C. § 119(a) of priority to Korean Patent Application No. 10-2022-0037663 filed on Mar. 25, 2022 in the Korean Intellectual Property Office, the entire disclosure of which is incorporated herein by reference for all purposes.

### BACKGROUND

### Technical Field

Embodiments of the disclosure relate to a stroke sensing apparatus for a brake pedal, and more particularly, to a stroke sensing apparatus for a brake pedal that may transmit a magnetic field change generated in a magnet part and detected by a sensor by positioning a pole piece part between the sensor and the magnet part, installed in a braking apparatus.

### Discussion of the Background

An electronic braking system needs to identify position of a brake pedal to identify a driver's will to brake.

In the prior art, a pedal sensor may be positioned in the brake pedal to measure a stroke of the pedal, thereby identifying the position of the brake pedal. However, in most of recent electric brakes, the pedal sensor may be positioned in the electronic braking system to measure a stroke of a cylinder.

In this case, a flow path structure in the electronic braking system may be very complicated, and accordingly, it may not be easy to dispose the sensor and magnet by design. Therefore, there is a need to solve this problem.

The related art of the disclosure is disclosed in Korean Patent Laid-Open Publication No. 10-2019-0037541 (published on Apr. 8, 2019, and entitled “INSTALLATION STRUCTURE FOR PEDAL STROKE SENSOR”).

### SUMMARY

Various embodiments are directed to a stroke sensing apparatus for a brake pedal that may transmit a magnetic field change generated in a magnet part a sensor by positioning a pole piece part between the sensor and the magnet part, installed in a braking apparatus.

In an embodiment, a stroke sensing apparatus for a brake pedal includes: a pedal rod movable by an operation of the brake pedal; a magnet part mounted on the pedal rod and movable together with the pedal rod; a sensor spaced apart from the magnet part; a printed circuit board (PCB) part on which the sensor is mounted; and a pole piece part spaced apart from the magnet part and transmitting a magnetic field change generated in the magnet part to the sensor.

The pole piece part may have one end facing the sensor, and an opposite end facing the magnet part.

The other end of the pole piece part may be spaced apart from the magnet part.

The pole piece part may be made of a magnetic material.

The pole piece part may include a pole piece body part having one end facing the sensor and an opposite end facing the magnet part, and a pole piece magnetic part made of the magnetic material and disposed in the pole piece body part.

The pole piece body part may include a plastic material, and the pole piece magnetic part may be injection-molded or assembled to the pole piece body part to form an integral body.

The pole piece body part may include a metal material, and the pole piece magnetic part may be assembled to the pole piece body part to form an integral body.

The plurality of pole piece magnetic parts may be stacked above each other in the pole piece body part.

The pole piece body part may have a cylindrical shape.

The pole piece magnetic part may have a plate shape.

The pole piece magnetic part may have a cylindrical shape.

The plurality of pole piece magnetic parts may be stacked above each other in the pole piece body part and have an “L” and/or inversed “L” shape.

The plurality of pole piece magnetic parts may be stacked above each other in the pole piece body part and have a “C” shape.

The plurality of pole piece magnetic parts may be stacked above each other in the pole piece body part and have an “R” shape.

The magnet part may include a magnet body, a magnet mounted in the magnet body, moved as the magnet body is moved, and spaced apart from the pole piece part, and a bracket having one side connected to the magnet body and an opposite side mounted on the pedal rod.

A surface of the pole piece part may be anti-rust plated or painted.

The magnet part and the pole piece part may be disposed in a pump housing in which a flow path part is positioned, and the sensor and the PCB may be disposed in an engine control unit (ECU) housing coupled to the pump housing.

According to the stroke sensing apparatus for a brake pedal of the disclosure, it is possible to transmit the magnetic field change generated in the magnet part to the sensor through the pole piece part, thereby eliminating the space constraint caused by the flow path part in the braking apparatus.

According to the disclosure, it is also possible to effectively and accurately sense the stroke of the brake pedal.

### BRIEF DESCRIPTION OF THE DRAWINGS

FIG. 1 is a perspective view schematically showing a stroke sensing apparatus for a brake pedal according to an embodiment of the disclosure.

FIG. 2 is a perspective view schematically showing a state where a pump housing is removed from the stroke sensing apparatus for a brake pedal according to an embodiment of the disclosure.

FIG. 3 is a front view schematically showing the stroke sensing apparatus for a brake pedal according to an embodiment of the disclosure.

FIG. 4 is a schematic operation diagram of the stroke sensing apparatus for a brake pedal according to an embodiment of the disclosure.

FIG. 5 is a perspective view schematically showing a first implementation example of a pole piece part of the disclosure.

FIG. 6 is a perspective view schematically showing a second implementation example of the pole piece part of the disclosure.

FIG. 7 is a perspective view schematically showing a third implementation example of the pole piece part of the disclosure.

FIG. 8 is a perspective view schematically showing a fourth implementation example of the pole piece part of the disclosure.

FIG. 9 is a perspective view schematically showing a fifth implementation example of the pole piece part of the disclosure.

FIG. 10 is a perspective view schematically showing a sixth implementation example of the pole piece part of the disclosure.

### DETAILED DESCRIPTION OF THE ILLUSTRATED EMBODIMENTS

Hereinafter, a stroke sensing apparatus for a brake pedal will be described below with reference to the accompanying drawings through various embodiments. It should be noted that the drawings may be exaggerated in thickness of lines or sizes of components for clarity and convenience of explanation.

In addition, terms used herein are those defined in consideration of their functions in the disclosure, and may be changed by practice or the intentions of users or operators.

Therefore, the definition of the terms should be made based on the contents throughout the specification.

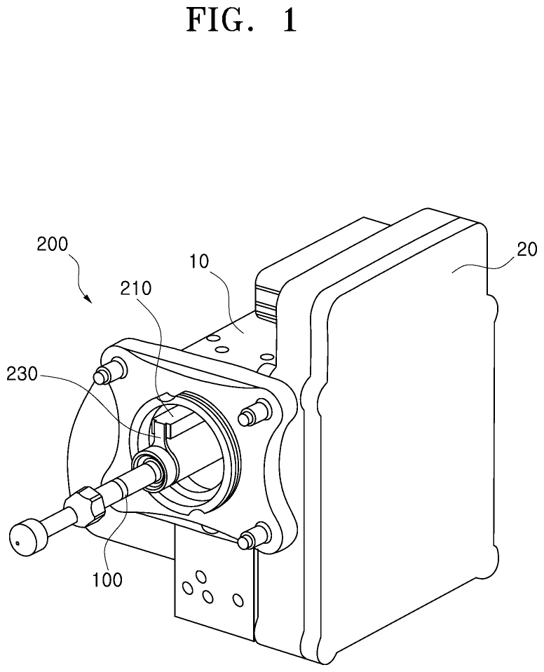

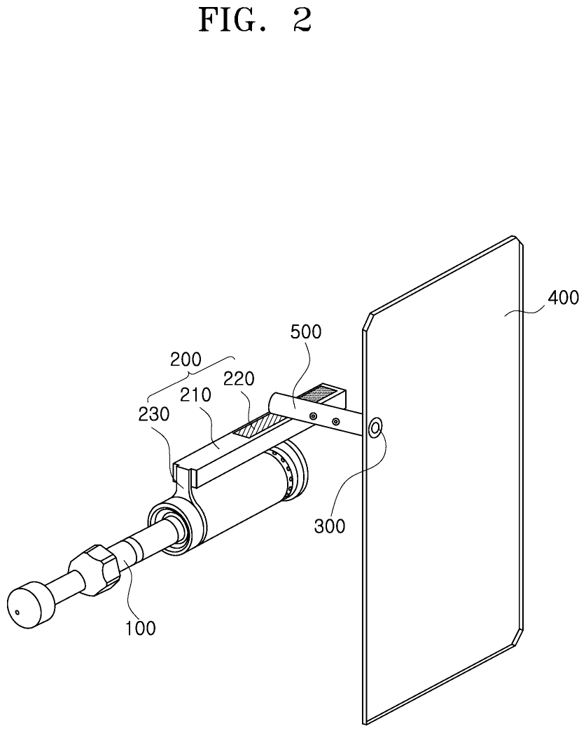

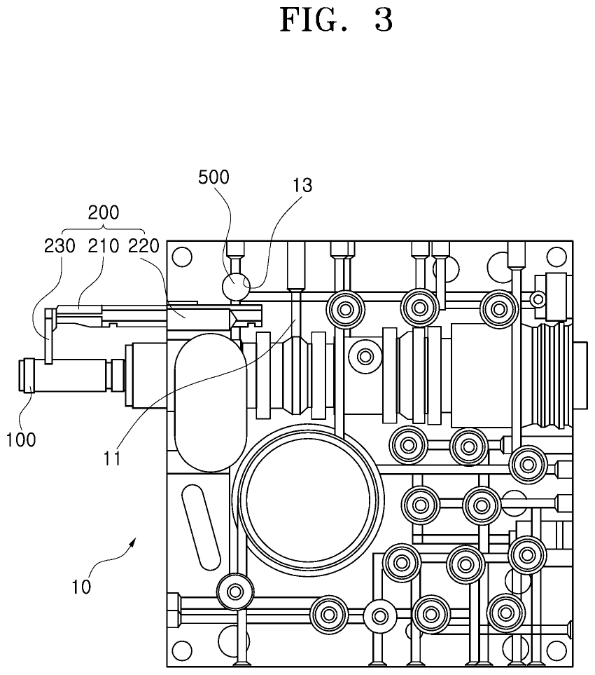

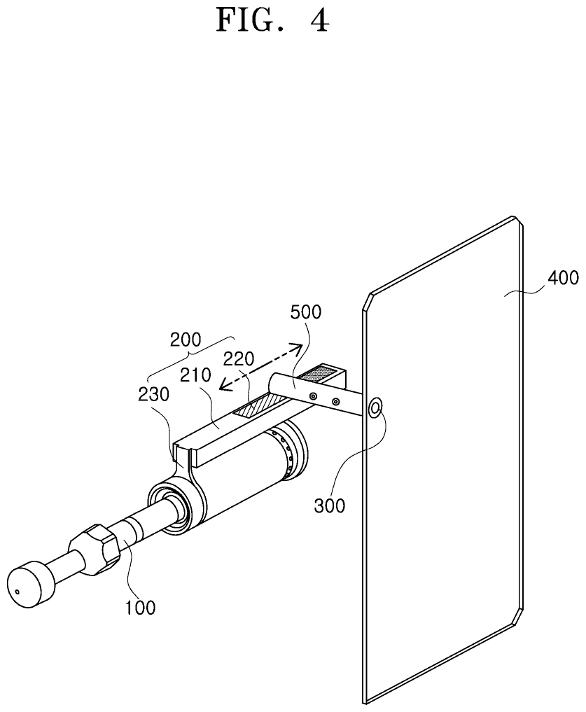

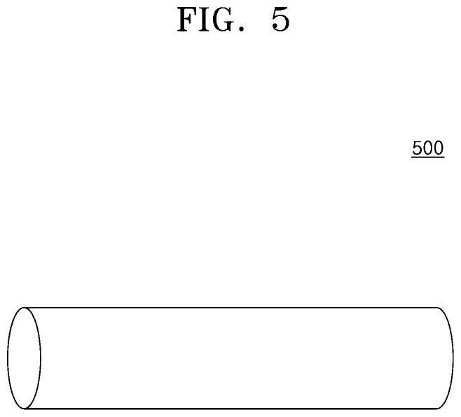

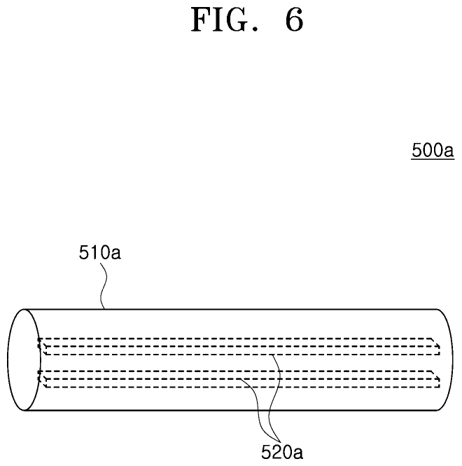

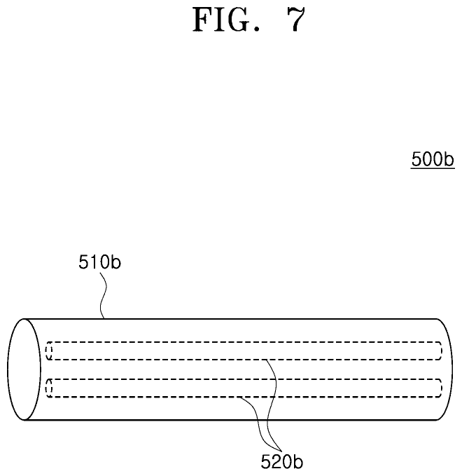

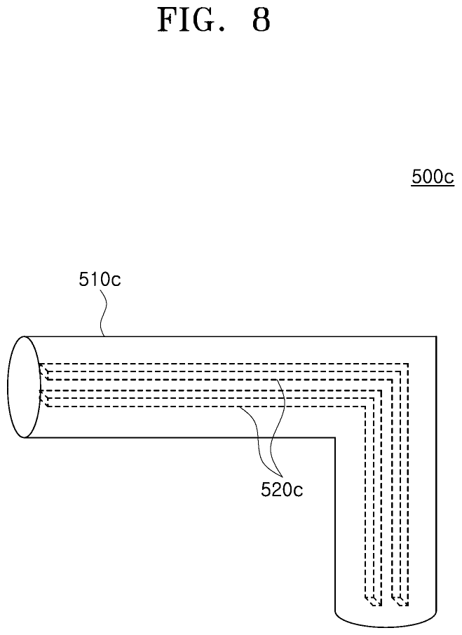

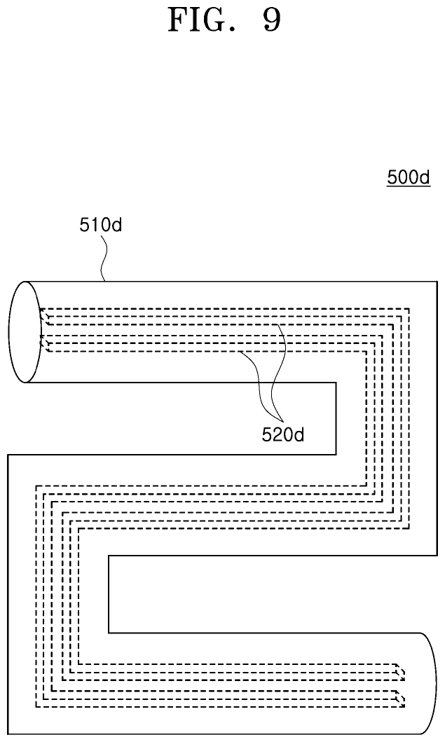

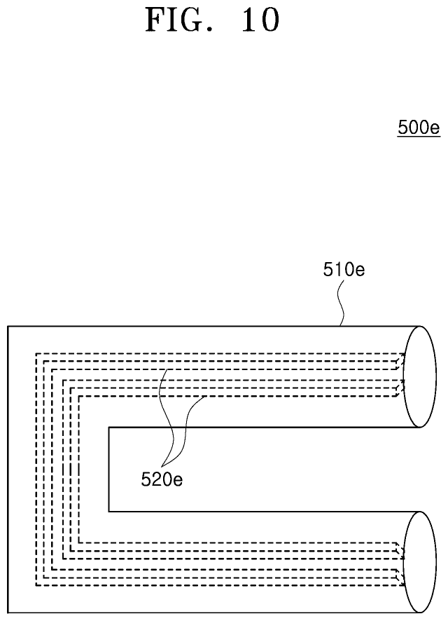

FIG. 1 is a perspective view schematically showing a stroke sensing apparatus for a brake pedal according to an embodiment of the disclosure; FIG. 2 is a perspective view schematically showing a state where a pump housing is removed from the stroke sensing apparatus for a brake pedal according to an embodiment of the disclosure; FIG. 3 is a front view schematically showing the stroke sensing apparatus for a brake pedal according to an embodiment of the disclosure; FIG. 4 is a schematic operation diagram of the stroke sensing apparatus for a brake pedal according to an embodiment of the disclosure; FIG. 5 is a perspective view schematically showing a first implementation example of a pole piece part of the disclosure; FIG. 6 is a perspective view schematically showing a second implementation example of the pole piece part of the disclosure; FIG. 7 is a perspective view schematically showing a third implementation example of the pole piece part of the disclosure; FIG. 8 is a perspective view schematically showing a fourth implementation example of the pole piece part of the disclosure; FIG. 9 is a perspective view schematically showing a fifth implementation example of the pole piece part of the disclosure; and FIG. 10 is a perspective view schematically showing a sixth implementation example of the pole piece part of the disclosure.

Referring to FIGS. 1 to 4, the stroke sensing apparatus for a brake pedal according to an embodiment of the disclosure may include a pedal rod 100, a magnet part 200, a sensor 300, a printed circuit board (PCB) part 400, and a pole piece part 500. The pole piece part 500 and the like may be accommodated in an inner space of a pump housing 10, and the pedal rod 100 and the magnet part 200 may be movably mounted in the pump housing 10.

The pump housing 10 may have the inner space which may accommodate the magnet part 200, the pole piece part 500, and the like, and include a flow path part 11 through which a fluid may flow. The flow path part 11 may control a flow of a pressurized medium such as brake oil that forms a hydraulic pressure. The magnet part 200 and the pole piece part 500 may be mounted in the pump housing 10 in which the flow path part 11 is positioned.

An engine control unit (ECU) housing 20 may be detachably coupled to one side (e.g., right side in FIG. 1) of the pump housing 10. The sensor 300 and the PCB 400 may be accommodated and disposed in an inner space of the ECU housing 20. The sensor 300 accommodated in the ECU housing 20 may transmit sensed stroke information of a brake pedal or that of a moving member to an electronic control unit (ECU, or electronic control system) of a vehicle.

The magnet part 200 and the pole piece part 500 may be disposed in the pump housing 10 in which the flow path part 11 is positioned, and the sensor 300 and the PCB 400 may be disposed in the ECU housing 20 coupled to the pump housing 10.

The sensor 300 and the PCB 400 disposed in the ECU housing 20 may be separated from the pump housing 10 including the flow path part 11. Therefore, the sensor 300 and the PCB 400 disposed in the ECU housing 20 may avoid interference with the flow path part 11 of the pump housing 10, thus enabling a free space arrangement and an easy design change.

The pedal rod 100 may be moved by an operation of the brake pedal (not shown). The pedal rod 100 may have one side (e.g., left side in FIG. 2) connected to the brake pedal and the other side connected to the moving member such as a piston, and the operation of the brake pedal may thus be transmitted to a stroke of the piston.

The moving member such as a piston may be connected to the brake pedal via the pedal rod 100, and generate the stroke by being moved forward and backward in the inner space of the pump housing 10 when a driver operates the brake pedal.

The magnet part 200 may be mounted on the pedal rod 100, and moved together with the pedal rod 100. The magnet part 200 may include a magnet body 210, a magnet 220, and a bracket 230.

The magnet body 210 may have one side (e.g., upper side in FIG. 2) open, and be elongated in a direction in which the pedal rod 100 is moved. The magnet 220 may be mounted in an inner space of the magnet body 210 having one side open. The magnet body 210 may be spaced apart from the pole piece part 500.

The magnet 220 may be mounted in the magnet body 210, moved as the magnet body 210 is moved, and spaced apart from the pole piece part 500. The magnet 220 may be made of a magnetic material (or magnet). The magnet 220 may have one side (e.g., left side in FIG. 2) disposed as an N pole, and the other side (e.g., right side in FIG. 2) disposed as an S pole. Alternatively, the magnet 220 may have one side (e.g., left side in FIG. 2) disposed as the S pole, and the other side (e.g., right side in FIG. 2) disposed as the N pole.

The magnet part 200 may be moved as the magnet body 210 is moved, and its magnetic field change from the N pole to the S pole (or from the S pole to the N pole) may thus be transmitted to the sensor 300 through the pole piece part 500.

The bracket 230 may have one side (e.g., upper side in FIG. 2) connected to the magnet body 210, and the other side (e.g., lower side in FIG. 2) mounted on the pedal rod 100. The magnet body 210 may be integrated with the pedal rod 100 by the bracket 230. Accordingly, the magnet 220 may be moved by the magnet body 210 that is moved as the pedal rod 100 is moved. The bracket 230 may have a U-shape with an open other side, and be removably and elastically coupled to the pedal rod 100.

The sensor 300 may be spaced apart from the magnet part 200. The sensor 300 may be mounted on the PCB 400. The sensor 300 may receive the magnetic field change generated in the magnet 220 of the magnet part 200 through the pole piece part 500.

Referring to FIG. 4, the magnet 220 of the magnet part 200 may be moved by the pedal rod 100 moved forward and backward in the inner space of the pump housing 10 based on the operation of the brake pedal, and the magnetic field change generated in the magnet 220 may be transmitted to the sensor 300 through the pole piece part 500.

The sensor 300 may sense the stroke of the brake pedal or that of the moving member by sensing magnetic field change generated in the magnet 220 of the magnet part 200. The sensor 300 may transmit the sensed stroke information of the brake pedal or that of the moving member to the ECU of the vehicle.

The PCB 400 may be disposed in the inner space of the ECU housing 20. The sensor 300 may be mounted on the PCB 400. The PCB 400 may be mounted with various electronic components, mounted on the ECU housing 20, and electrically connected to the ECU.

The PCB 400 may be connected to the ECU and electrically receive control information on vehicle braking from the ECU.

The pole piece part 500 may be mounted in the pump housing 10, spaced apart from the magnet part 200, and transmit the magnetic field change generated in the magnet part 200 to the sensor 300. The pole piece part 500 may be disposed orthogonally to the magnet 220.

The pump housing 10 may include a mounting hole part 13 in which the pole piece part 500 may be mounted. The pole piece part 500 may be inserted into the mounting hole part 13 and mounted in the pump housing 10. Therefore, there is no need for a separate means for supporting the pole piece part 500, and the pole piece part 500 may be mounted in the mounting hole part 13 of the pump housing 10.

The pole piece part 500 may have one end facing the sensor 300, and the other end facing the magnet part 200. The other end of the pole piece part 500 may be spaced apart from the magnet part 200.

The pole piece part 500 may be made of the magnetic material. The pole piece part 500 may be made of the magnetic material, and transmit the magnetic field change generated in the magnet 220 of the magnet part 200 to the sensor 300.

Referring to FIG. 5, the pole piece part 500 in the first implementation example of the disclosure may have a cylindrical shape. The pole piece part 500 may have an outer diameter smaller than that of the sensor 300. The pole piece part 500 may be made of a ferromagnetic material. The pole piece part 500 may be made of the ferromagnetic material, and transmit the magnetic field change generated in the magnet 220 of the magnet part 200 to the sensor 300 without loss. A surface of the pole piece part 500 may be anti-rust plated, painted or coated to prevent rust.

A pole piece part 500a, 500b, 500c, 500d, or 500e described below may include a pole piece body part 510a, 510b, 510c, 510d, or 510e and a pole piece magnetic part 520a, 520b, 520c, 520d, or 520e.

The pole piece body part 510a, 510b, 510c, 510d, or 510e may have one end facing the sensor 300 and the other end facing the magnet 220 of the magnet part 200. The other end of the pole piece body part 510a, 510b, 510c, 510d, or 510e may be spaced apart from the magnet 220 of the magnet part 200.

The pole piece body part 510a, 510b, 510c, 510d, or 510e may have an outer diameter smaller than that of the sensor 300.

The pole piece magnetic part 520a, 520b, 520c, 520d, or 520e may be made of the magnetic material and disposed in the pole piece body part 510a, 510b, 510c, 510d, or 510e. The pole piece magnetic part 520a, 520b, 520c, 520d, or 520e may be made of the ferromagnetic material and disposed in the pole piece body part 510a, 510b, 510c, 510d, or 510e.

The plurality of pole piece magnetic parts 520a, 520b, 520c, 520d, or 520e may be stacked above each other in the pole piece body part 510a, 510b, 510c, 510d, or 510e.

The pole piece body part 510a, 510b, 510c, 510d, or 510e may include a plastic material or a metal material.

When the pole piece body part 510a, 510b, 510c, 510d, or 510e includes the plastic material, the pole piece magnetic part 520a, 520b, 520c, 520d, or 520e may be injection-molded or assembled to the pole piece body part 510a, 510b, 510c, 510d, or 510e to form an integral body.

When the pole piece body part 510a, 510b, 510c, 510d, or 510e includes the metal material, the pole piece magnetic part 520a, 520b, 520c, 520d, or 520e may be integrally formed with or assembled to the pole piece body part 510a, 510b, 510c, 510d, or 510e to form an integral body.

The pole piece magnetic part 520a, 520b, 520c, 520d, or 520e may be injection-molded into the pole piece body part 510a, 510b, 510c, 510d, or 510e, and the pole piece part 500a, 500b, 500c, 500d, 500e may thus require less time for its replacement or assembling.

Alternatively, the pole piece magnetic part 520a, 520b, 520c, 520d, or 520e may be assembled to the pole piece body part 510a, 510b, 510c, 510d, or 510e, and the pole piece part 500a, 500b, 500c, 500d, 500e may thus be easily replaced or repaired. The plurality of pole piece magnetic parts 520a, 520b, 520c, 520d, or 520e may be stacked above each other in the pole piece body part 510a, 510b, 510c, 510d, or 510e. The plurality of pole piece magnetic part 520a, 520b, 520c, 520d, or 520e may be stacked above each other in the pole piece body part 510a, 510b, 510c, 510d, or 510e, and the magnetic field change generated in the magnet 220 of the magnet part 200 may thus be transmitted effectively to the sensor 300.

Referring to FIG. 6, the pole piece body part 510a in the second implementation example of the disclosure may have a cylindrical shape. The pole piece magnetic part 520a may have a plate shape. The pole piece magnetic parts 520a may be vertically stacked above each other in the pole piece body part 510a.

Referring to FIG. 7, the pole piece body part 510b in the third implementation example of the disclosure may have a cylindrical shape. The pole piece magnetic part 520b may have a cylindrical shape disposed in an inner space of the pole piece body part 510b. The pole piece magnetic parts 520b may be vertically stacked above each other in the pole piece body part 510b.

Referring to FIG. 8, the pole piece body part 510c in the fourth implementation example of the disclosure may have a cylindrical shape. The plurality of pole piece magnetic parts 520c may be stacked above each other in the pole piece body part 510c while having an “L” or inversed “L” shape.

Referring to FIG. 9, the pole piece body part 510d in the fifth implementation example of the disclosure may have a cylindrical shape. The plurality of pole piece magnetic parts 520d may be stacked above each other in the pole piece body part 510d while having an “R” shape.

Referring to FIG. 10, the pole piece body part 510e in the sixth implementation example of the disclosure may have a cylindrical shape. The plurality of pole piece magnetic parts 520e may be stacked above each other in the pole piece body part 510e while having a “C” shape.

As shown in FIGS. 9 and 10, the pole piece body part 510c, 510d, or 510e in the disclosure may have a shape corresponding to that of the pole piece magnetic part 520c, 520d, or 520e.

According to the stroke sensing apparatus for a brake pedal of the disclosure, it is possible to transmit the change in the magnetic field of the magnet part to the sensor through the pole piece part, thereby eliminating the space constraint caused by the flow path part in the braking apparatus.

According to the disclosure, it is also possible to effectively and accurately sense the stroke of the brake pedal.

Although the embodiments of the disclosure have been disclosed for illustrative purposes, those skilled in the art will appreciate that various modifications, additions and substitutions are possible, without departing from the scope and spirit of the disclosure as defined in the accompanying claims. Thus, the true technical scope of the disclosure should be defined by the following claims.

What is claimed is:

1. A stroke sensing apparatus for a brake pedal, the apparatus comprising:
a pedal rod movable by an operation of the brake pedal;
a magnet part mounted on the pedal rod and movable together with the pedal rod;
a sensor spaced apart from the magnet part;
a printed circuit board (PCB) part on which the sensor is mounted; and
a pole piece part spaced apart from the magnet part and configured to transmit a magnetic field change generated in the magnet part to the sensor.

2. The apparatus of claim 1, wherein the pole piece part has one end facing the sensor, and an opposite end facing the magnet part.

3. The apparatus of claim 2, wherein the opposite end of the pole piece part is spaced apart from the magnet part.

4. The apparatus of claim 1, wherein the pole piece part is made of a magnetic material.

5. The apparatus of claim 1, wherein the pole piece part includes:
a pole piece body part having one end facing the sensor and an opposite end facing the magnet part, and
a pole piece magnetic part made of a magnetic material and disposed in the pole piece body part.

6. The apparatus of claim 5, wherein the pole piece body part includes a plastic material, and the pole piece magnetic part is injection-molded or assembled to the pole piece body part to form an integral body therewith.

7. The apparatus of claim 5, wherein the pole piece body part includes a metal material, and the pole piece magnetic part is assembled to the pole piece body part to form an integral body therewith.

8. The apparatus of claim 5, wherein the plurality of pole piece magnetic parts are stacked above each other in the pole piece body part.

9. The apparatus of claim 8, wherein the pole piece body part has a cylindrical shape.

10. The apparatus of claim 8, wherein the pole piece magnetic part has a planar shape.

11. The apparatus of claim 8, wherein the pole piece magnetic part has a cylindrical shape.

12. The apparatus of claim 10, wherein the plurality of pole piece magnetic parts are stacked above each other in the pole piece body part and have an “L” and/or inverted “L” shape.

13. The apparatus of claim 10, wherein the plurality of pole piece magnetic parts are stacked above each other in the pole piece body part and have a “C” shape.

14. The apparatus of claim 10, wherein the plurality of pole piece magnetic parts are stacked above each other in the pole piece body part and have an “R” shape.

15. The apparatus of claim 1, wherein the magnet part includes
a magnet body,
a magnet mounted in the magnet body, moved as the magnet body is moved, and spaced apart from the pole piece part, and
a bracket having one side connected to the magnet body and an opposite side mounted on the pedal rod.

16. The apparatus of claim 1, wherein a surface of the pole piece part is anti-rust plated or painted.

17. The apparatus of claim 1, wherein the magnet part and the pole piece part are disposed in a pump housing in which a flow path part is positioned, and
the sensor and the PCB are disposed in an engine control unit (ECU) housing coupled to the pump housing.
